(19) United States
(12) Patent Application Publication
(10) Pub. No.: US 2024/0391221 A1
(43) Pub. Date: Nov. 28, 2024

(54) BULLETPROOF PILLOW

(71) Applicant: IMPORT KALEIDOSCOPE CC, PRETORIA (ZA)

(72) Inventors: Marius Wilken VAN SCHALKWYK, PRETORIA (ZA); Hendrik Petrus NAUDÉ, PRETORIA (ZA)

(21) Appl. No.: 18/669,615

(22) Filed: May 21, 2024

(30) Foreign Application Priority Data
May 26, 2023 (ZA) 2023/05667

(51) Int. Cl. B32B 27/08; B32B 3/04; B32B 5/02; B32B 5/18; B32B 27/06; B32B 27/12; B32B 27/32; B32B 27/42

(52) U.S. Cl. CPC B32B 27/08; B32B 3/04; B32B 5/02; B32B 5/18; B32B 27/065; B32B 27/12; B32B 27/32; B32B 27/42; B32B 2250/05; B32B 2307/558; B32B 2307/72; B32B 2307/7376; B32B 2571/02

(57) ABSTRACT

A bulletproof pillow which comprises an impact protective arrangement which includes a first element which comprises overlying layers formed from a material selected from the group consisting of meta-aramids, para-aramids, ultra-high molecular weight polyethylene, polyethylene terephthalate, cellulose, polyamide, a mixture of para-aramids and meta-aramids, and a mixture of para-aramids and carbon; and a pair of cushioned supports which can be secured to an operatively upper and lower surface of the impact protective arrangement.

### CROSS-REFERENCE TO A RELATED APPLICATION

The present application claims priority to South African Application No. 2023/05667, filed May 26, 2023, which is hereby incorporated by reference herein in its entirety, including any figures, tables, and drawings.

### INTRODUCTION TO THE INVENTION

This invention relates to the field of personal safety and protection. More particularly but not exclusively, the invention relates to a bulletproof pillow that provides an added layer of protection to individuals during an emergency situation such as a ballistic or stabbing attack.

### BACKGROUND TO THE INVENTION

In recent years, there has been an increase in gun violence and stabbing incidents, and the need for personal safety and protection has become a paramount concern for individuals. Ballistic attacks can occur at any time, and individuals need to take measures to protect themselves in such situations.

Currently, there are several bulletproof products available in the market, such as bulletproof vests, bulletproof jackets, bulletproof helmets, and bulletproof backpacks. While these products are effective in providing protection against ballistic attacks, they have certain limitations that make them less practical or suitable for use in certain situations.

These bulletproof products are mainly effective in situations where a user anticipates the danger or fear of a ballistic attack and wear the bulletproof product in anticipation. Bulletproof vests/jackets can furthermore be heavy and uncomfortable to wear for extended periods and as such most users do not wear them in relaxed scenarios where the user does not anticipate danger such as when they are home, sleeping, or relaxing. Furthermore, bulletproof vests are usually stored away when a user does not anticipate danger and is not easily accessible when required in an emergency situation.

There is therefore a clear need for a bulletproof article which is effective in protecting a user against ballistic attacks and stabbing attacks and is easily accessible in relaxed scenarios where the user does not anticipate danger such as when they are home, sleeping, or relaxing.

Current soft armour inserts which consist of layers of para-aramid synthetic fibres are manufactured to be placed in a predetermined orientation in bulletproof vests. There have been attempts to place such soft armour inserts in a pillow. A drawback of this is that a user is required to direct the pillow in the predetermined orientation towards the ballistic attack to ensure effective protection which may be troublesome in an emergency.

### OBJECT OF THE INVENTION

It is accordingly an object of the present invention to provide a bulletproof pillow with which the applicant believes the aforementioned limitations and disadvantages may largely or wholly be alleviated, and/or which would provide an alternative for known bulletproof products.

### SUMMARY OF THE INVENTION

According to a first aspect of the invention, there is provided a bulletproof pillow which comprises:
an impact protective arrangement which includes a first element which comprises overlying layers formed from a material selected from the group consisting of meta-aramids, para-aramids, ultra-high molecular weight polyethylene, polyethylene terephthalate, cellulose, polyamide, a mixture of para-aramids and meta-aramids, a mixture of para-aramids and carbon, and a combination thereof; and
a pair of cushioned supports which can be secured to an operatively upper and lower surface of the impact protective arrangement.

It is to be appreciated that the bulletproof pillow can be of any shape or size. More specifically, the bulletproof pillow may also be in the form of a bulletproof mattress, a bulletproof cushion, or any other associated bulletproof article which can be used as a comfortable support by a user.

The impact protective arrangement may include at least one second element which comprises a layer formed from a material selected from the group consisting of meta-aramids, para-aramids, ultra-high molecular weight polyethylene, polyethylene terephthalate, cellulose, polyamide, a mixture of para-aramids and meta-aramids, a mixture of para-aramids and carbon, and a combination thereof, the layer being encased in an elastomer. More specifically, the layer of the at least one second element may be encased in a polyurea elastomer.

In a preferred embodiment, the impact protective arrangement may include a plurality of second elements, more specifically two second elements, which are arranged at an uppermost layer and lowermost layer of the first element such that the first element is located between the two second elements.

In an alternative embodiment, the impact protective arrangement may include one second element and two first elements. In such an embodiment, the second element may be positioned between the two first elements.

The impact protective arrangement may include at least one third element which comprises a high-density foam layer. In a preferred embodiment, the impact protective arrangement may include a plurality of third elements, more specifically two third elements, which are arranged at an uppermost and lowermost layer of the plurality of the second elements or first elements such that the first and second elements are located between the two third elements.

In a first example configuration the impact protective arrangement may have the following configuration: third element, second element, first element, second element, and third element. The different elements of the impact protective arrangement may be secured to one another with a pair of cushioned supports secured to an operatively upper and lower surface of the impact protective arrangement.

In a second example embodiment the impact protective arrangement may have the following configuration: third element, first element, second element, first element, and third element. The different elements of the impact protective arrangement may be secured to one another with the pair of cushioned supports secured to an operatively upper and lower surface of the impact protective arrangement.

It is to be appreciated that the configuration of the elements of the impact protective arrangement may be adjusted as required.

The impact protective arrangement may be substantially flexible.

The impact protective arrangement may further include a cover in which the first element, the plurality of second elements, and the plurality of third elements are housed.

The cover may include webbing which extend lengthwise across an upper and lower surface of the cover to provide additional strength and stability to the impact protective arrangement.

The impact protective arrangement may further include at least one handle which extends outwardly from the impact protective arrangement. The handle may be secured to the cover of the impact protective arrangement and extend away from the pair of cushioned supports such that a user may easily carry the bulletproof pillow. Preferably, the handle may be secured to the webbing on opposed sides of the impact protective arrangement. In a preferred embodiment, the impact protective arrangement includes a pair of handles extending from both sides of the impact protective arrangement.

The bulletproof pillow may be housed in an outer fabric casing such as a pillowcase. The pillowcase may include at least one opening through which the at least one handle may extend outwardly.

The layers of the first element and the second element may be formed by interlacing yarn of fibres selected from the group consisting of a meta-aramid fibre, a para-aramid fibre, an ultra-high molecular weight polyethylene fibre, a polyethylene terephthalate fibre, a cellulose fibre, a polyamide fibre, a mixture of para-aramid fibres and meta-aramid fibres and a mixture of para-aramid fibres and carbon fibres, and a combination thereof. Alternatively, the layers of the first element and the second element may be formed by sintering a powder of a material selected from the group consisting of meta-aramids, para-aramids, ultra-high molecular weight polyethylene, polyethylene terephthalate, a cellulose, a polyamide, a mixture of para-aramid and meta-aramid and a mixture of para-aramid and carbon, and a combination thereof.

Preferably the layers of the first element and the second element comprise ultra-high molecular weight polyethylene that is formed into a layer having an area density of between 50±8 gram per square metre (g/m²) and 300±8 gram per square metre (g/m²).

The ultra-high molecular weight polyethylene layers may each have a thickness of between 0.07±0.02 millimetres (mm) and 0.40±0.02 millimetres (mm).

The first element may comprise at least 10, preferably at least 16 ultra-high molecular weight layers. The plurality of ultra-high molecular weight layers may be grouped into sets, wherein several sets form the first element. The ultra-high molecular weight layers of each set may be attached to one another.

The second element may have a thickness of between 0.5 millimetres (mm) and 5 millimetres (mm).

The third element may have a thickness of between 1 millimetre (mm) and 7 millimetres (mm).

The impact protective arrangement and the pair of cushioned supports may include corresponding securing means so that they are removably secured. In a preferred embodiment, the securing means may be in the form of hook and loop fasteners. Alternatively, the securing means may be in the form of press studs or the like. The corresponding securing means may be located on an upper and lower surface of the impact protective arrangement and an operatively inner layer of the pair of cushioned supports.

In one example embodiment, pair of cushioned supports may comprise a filler material which is enclosed in a fabric cover. The filler material may be selected from the group consisting of wool, polyester, feathers, cotton, down fibres, or the like, or any combination thereof. In an alternative embodiment, the pair of cushioned support may be in the form of high-density foam such as memory foam.

In the case where the impact protective pillow has an increased surface area and is intended to be used as a mattress, the cushioned supports may comprise several layers of high-density foam, support foam, memory foam, coil springs, or the like, or any combination thereof.

The impact protective pillow may further include an additional protective layer which may either be housed within the impact protective arrangement or be removably secured to the impact protective arrangement. The additional protective layer may be in the form of a ballistic plate which is supported in a plate carrier incorporated in the impact protective arrangement. The ballistic plate may be any ballistic plate known in the art.

These and other features of the invention are described in more detail below.

### BRIEF DESCRIPTION OF THE ACCOMPANYING DRAWINGS

The invention will now be described by way of example only with reference to the accompanying drawings wherein:

FIG. 1 is an exploded perspective view of an impact protective arrangement of a bulletproof pillow in accordance with an example embodiment of the invention;

FIG. 2 is a perspective view of the impact protective arrangement of FIG. 1;

FIG. 3 is an exploded perspective view of a bulletproof pillow in accordance with an example embodiment of the invention;

FIG. 4 is a perspective view of the bulletproof pillow of FIG. 3;

FIG. 5 is a perspective view of the bulletproof pillow of FIG. 4 housed within a pillowcase.

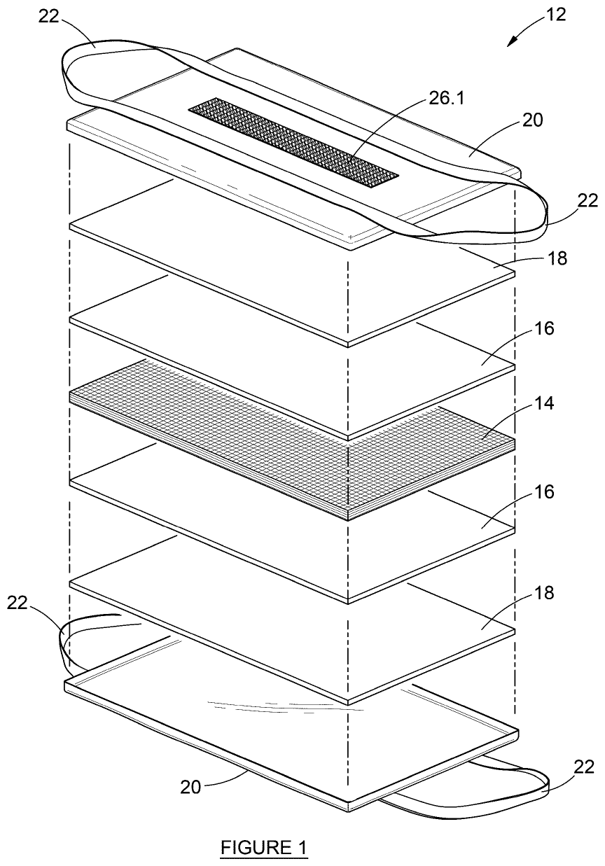

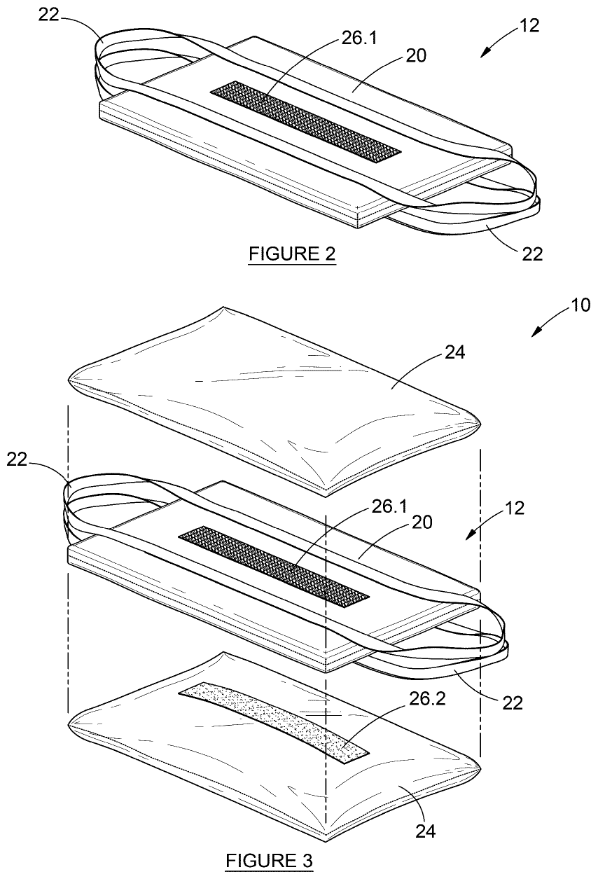

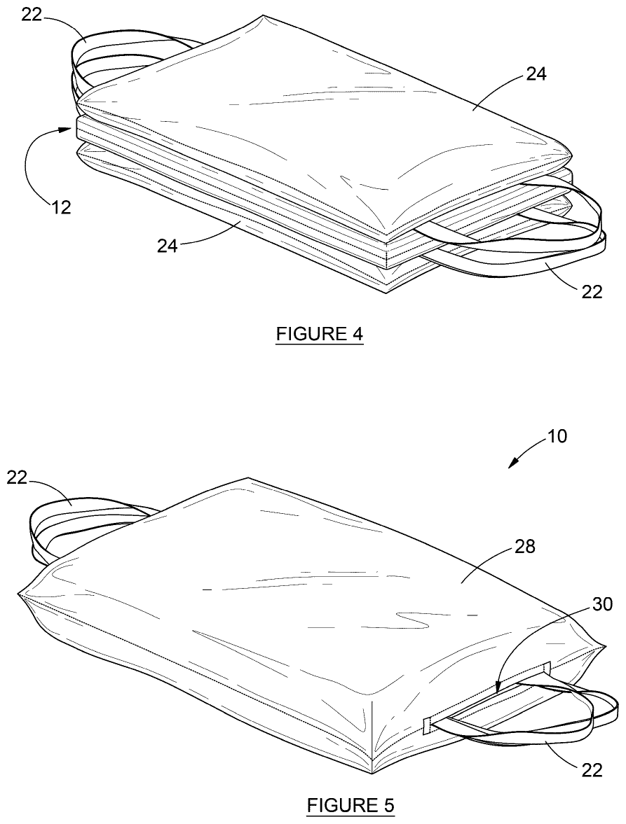

### DETAILED DESCRIPTION OF AN EXAMPLE EMBODIMENT OF THE INVENTION

Referring to the figures, in which like features are indicated by like numerals, a bulletproof pillow in accordance with the invention is generally designated by reference numeral 10. It is to be appreciated that the bulletproof pillow 10 can be of any shape or size. More specifically, the bulletproof pillow 10 can be in the form of a bulletproof mattress, a bulletproof cushion, or any other associated bulletproof article which can be used as a comfortable support by a user.

The bulletproof pillow 10 includes an impact protective arrangement 12 which is located and secured between a pair of cushioned support 24. The impact protective arrangement 12 includes a first element 14, a plurality of second elements 16, and a plurality of third elements 18.

The first element 14 comprises overlying layers formed from a material selected from the group consisting of meta-aramids, para-aramids, ultra-high molecular weight polyethylene, polyethylene terephthalate, cellulose, polyamide, a mixture of para-aramids and meta-aramids, and a mixture of para-aramids and carbon.

More specifically the first element 14 comprises a plurality of overlying ultra-high molecular weight polyethylene layers. Each of the ultra-high molecular weight polyethylene layers has an area density of approximately 160±8 grams per square metre (g/m²) and a thickness of approximately 0.21±0.02 millimetres. The plurality of ultra-high molecular weight polyethylene layers (not shown) are typically grouped into sets (not shown), where a number of sets form the first element 14. To form a set, several ultra-high molecular weight polyethylene layers are attached to one another at a peripheral region of each of the ultra-high molecular weight polyethylene layers forming the set. The number of ultra-high molecular weight polyethylene layers are typically secured to one another at a peripheral region of each of the ultra-high molecular weight polyethylene layers. As a first example, for level IIIA protection the first element 14 having ultra-high molecular weight polyethylene layers are grouped into four sets, where each set comprises four ultra-high molecular weight polyethylene layers. As a second example, the first element 14 having ultra-high molecular weight polyethylene layers can be grouped into two sets, with each set comprising eight ultra-high molecular weight polyethylene layers or alternatively into one set comprising sixteen ultra-high molecular weight polyethylene layers.

In this example embodiment, the impact protective arrangement 12 includes two second elements 16 which are arranged at an uppermost layer and lowermost layer of the first element 14, such that the first element 14 is located between the two second elements 16.

Each of the second elements 16 comprises a layer formed from a material selected from the group consisting of meta-aramids, para-aramids, ultra-high molecular weight polyethylene, polyethylene terephthalate, cellulose, polyamide, a mixture of para-aramids and meta-aramids and a mixture of para-aramids and carbon, and a combination thereof, the layer being encased in an elastomer. More specifically, the layer of the second element is encased in an elastomer such as a polyurea.

Even more specifically, each of the second elements 16 comprises at least one ultra-high molecular weight polyethylene layer that is encased in polyurea. The polyurea encasing is the reaction product of an aromatic or aliphatic isocyanate component and a synthetic resin. The reaction product contains between 60% and 100% solids.

The second element 16 has a thickness of between 0.5 millimetres (mm) and 5 millimetres (mm). As an example, a polyurea layer having a thickness of approximately 0.5 millimetres (mm) is located on each side of the ultra-high molecular weight polyethylene layer which is encased in polyurea. The polyurea which encases the ultra-high molecular weight polyethylene layer, surrounds the said ultra-high molecular weight polyethylene layer on all sides and around its edges.

In this example embodiment the impact protective arrangement 12 includes two third elements 18, which are arranged at an uppermost layer and lowermost layer of the second elements 16 such that the first element 14 and the second elements 16 are located between the two third elements 18.

Each of the third elements 18 comprises a layer of high-density foam. The layer of high-density foam typically has a thickness of between 1 millimetre (mm) and 7 millimetres (mm).

In the example embodiment as shown, the impact protective arrangement is arranged in the following configuration: third element, second element, first element, second element, third element. In this example embodiment for level IIIA protection the first element 14 having ultra-high molecular weight polyethylene layers are grouped into four sets, where each set comprises four ultra-high molecular weight polyethylene layers. In an alternative embodiment (not shown) the polyurea is centrally located, i.e., the impact protective arrangement is arranged in the following configuration: third element, first element, second element, first element, third element.

It is to be appreciated that the configuration of the impact protective arrangement may be adjusted based on the desired level of protection and intended use. For example, the sequence of the impact protective arrangement may be: third element, first element, second element, first element, third element. In such an example embodiment, the first element 14 having ultra-high molecular weight polyethylene layers can be grouped one set comprising twelve ultra-high molecular weight polyethylene layers or alternatively into two sets comprising six ultra-high molecular weight polyethylene layers.

The impact protective arrangement 12 further includes a cover 20 in which the first 14, the second elements 16, and the third elements 18 are housed.

The impact protective arrangement 12 further includes a set of handles 22 which extends away from the impact protective arrangement 12 from both sides. The set of handles 22 is secured to the cover 20 of the impact protective arrangement 12. In this example embodiment, the set of handles are in the form of elongated fabric straps which are secured at both ends to the cover 20. More specifically, the set of handles are in the form of webbing.

The pair of cushioned supports 24 are secured to an upper surface and a lower surface of the impact protective arrangement 12 such that the impact protective arrangement 12 is located between the pair of cushioned supports 24. The pair of cushioned supports 24 and the impact protective arrangement 12 includes corresponding securing means 26.1,26.2 so that the impact protective arrangement 12 and the pair of cushioned supports 24 are removably secured to each other allowing the pair of cushioned supports 24 to be replaced if needed.

In this example embodiment the corresponding securing means 26.1,26.2 is in the form of hook and loop fasteners. The hook and loop fasteners 26.1 are located on the upper and lower surface of the impact protective arrangement 12 with corresponding hook and loop fasteners 26.2 located on an operatively inner layer of the pair of cushioned support.

It is to be appreciated that the securing means may be in the form of any suitable securing means such as press studs so that the impact protective arrangement and the pair of foam/cushioned support are removably secured to one another.

The composition of the pair of cushioned supports 24 is based on the required use of the bulletproof pillow. In this example embodiment, the composition of the pair of cushioned supports 24 can be similar to the composition of known pillows. For example, each of the cushioned supports 24 may comprise a filler material (not shown) which is enclosed in a fabric cover (not shown). The filler material may be selected from the group consisting of wool, polyester, feathers, cotton, down fibres, or the like, or any combination thereof. Alternatively, each cushioned support 24 is in the form of high-density foam such as memory foam.

In the case where the bulletproof support has an increased surface area and is to be used as a bulletproof mattress (not shown in the Figures), the composition of the pair of cushioned support 24 may be similar to the composition of known mattresses. For example, each of the cushioned support may comprise several layers selected from the group consisting of high-density foam, support foam, memory foam, coil springs, or the like, or any combination thereof.

The impact protective cushion may further include an additional protective layer (not shown) which may either be housed within the impact protective arrangement or be removably secured to the impact protective arrangement. The additional protective layer may be in the form of a ballistic plate which is supported in a plate carrier incorporated within the impact protective arrangement. The additional protective layer provides additional ballistic protection when required. The ballistic plate may be any ballistic plate known in the prior art.

The impact protective arrangement and the pair of cushioned supports are housed in an outer fabric casing 28. The outer fabric casing in this example embodiment is in the form of a pillowcase. With the impact protective arrangement 12 and pair of cushioned supports 24 housed in the outer fabric casing 28 the set of handles 22 extends from the impact protective arrangement 12 through slots 30 in the outer fabric casing 28.

The number of overlying ultra-high molecular weight polyethylene layers used in the first element 14 depends on the level of protection sought. As an example, for a Level II (as classified by the United States National Institute of Justice) bulletproof product, the first element 14 will comprise between 6 and 28 overlying ultra-high molecular weight polyethylene layers. As a further example, for a Level IIIA (as classified by the United States National Institute of Justice), the first element 14 will comprise between 10 and 36 overlying ultra-high molecular weight polyethylene layers. Advantageously, a bulletproof pillow that incorporates the impact protective arrangement 12 provides excellent stopping power to a ballistic threat and protection against trauma as the result of an impact of the ballistic or knife threat. More particularly, the first element 14 provides the stopping power and the second element 16 provides the protection against trauma. Furthermore, the third element 18, and the cushioned support provides for a comfortable bulletproof support.

As the second element 16 and third element 18 are positioned on both sides of the first element 14, the bulletproof pillow 10 allows ballistic protection from both sides of the pillow. This allows a user to direct either side of the bulletproof pillow to a threat while ensuring the required level of protection.

It will be appreciated that the current invention provides a bulletproof pillow which is effective in providing protection against ballistic attacks and or stabbing attacks/piercing threats and which is easily accessible in relaxed scenarios where the user does not anticipate danger such as when they are at home, sleeping, or relaxing.

The applicant therefore believes that the present invention presents a unique alternative to current bulletproof products which are heavy and uncomfortable to wear for extended periods.

It will be appreciated by those skilled in the art, that the invention is not limited to the precise details as herein described and that many different configurations are possible without departing from the scope of the claims. The bulletproof pillow can easily be adapted to have an increased surface area where the bulletproof pillow can be in the form of a mattress or any other type of cushion, blanket or carpet.

The description is presented in the cause of providing what is believed to be the most useful and readily understood description of the principles and conceptual aspects of the invention. In this regard, no attempt is made to show structural details of the invention in more detail than is necessary for a fundamental understanding of the invention, nor is it intended to imply any form of constraint in adapting the concepts and the design layout.

The invention claimed is:

1. A bulletproof pillow comprising:
an impact protective arrangement which includes a first element which comprises overlying layers formed from a material selected from the group consisting of meta-aramids, para-aramids, ultra-high molecular weight polyethylene, polyethylene terephthalate, cellulose, polyamide, a mixture of para-aramids and meta-aramids, a mixture of para-aramids and carbon, and a combination thereof; and
a pair of cushioned supports operatively secured respectively to an operatively upper and lower surface of the impact protective arrangement.

2. The bulletproof pillow according to claim 1, wherein the impact protective arrangement includes at least one second element which comprises a layer formed from a material selected from the group consisting of meta-aramids, para-aramids, ultra-high molecular weight polyethylene, polyethylene terephthalate, cellulose, polyamide, a mixture of para-aramids and meta-aramids, a mixture of para-aramids and carbon, and a combination thereof, the layer being encased in an elastomer and wherein the layer of the at least one second element is encased in a polyurea elastomer.

3. The bulletproof pillow according to claim 2, wherein the impact protective arrangement comprises:
A) two second elements, which are arranged at an uppermost layer and lowermost layer of the first element such that the first element is located between the two second elements; or
B) one second element and two first elements, and wherein the second element is positioned between the two first elements.

4. The bulletproof pillow according to claim 3, wherein the impact protective arrangement includes at least one third element which comprises a high-density foam layer and wherein the impact protective arrangement comprises two third elements, which are arranged at an uppermost and lowermost layer of the plurality of the second elements or first elements such that the first and second elements are located between the two third elements.

5. The bulletproof pillow according to claim 4, wherein the different elements of the impact protective arrangement are secured to one another with a pair of cushioned supports secured to an operatively upper and lower surface of the impact protective arrangement, the different elements of the impact protective arrangement being secured to one another with the pair of cushioned supports secured to an operatively upper and lower surface of the impact protective arrangement.

6. The bulletproof pillow according to claim 5, wherein the impact protective arrangement is flexible and further includes a cover in which the first element, the plurality of second elements, and the plurality of third elements are housed and wherein the cover includes webbing which extend lengthwise across an upper and lower surface of the cover to provide additional strength and stability to the impact protective arrangement.

7. The bulletproof pillow according to claim 6, wherein the impact protective arrangement further includes:
at least one handle which extends outwardly from the impact protective arrangement;
the handle being secured to the cover of the impact protective arrangement and extends away from the pair of cushioned supports such that a user may easily carry the bulletproof pillow;
the handle being further secured to the webbing on opposite sides of the impact protective arrangement,
the arrangement being such that the impact protective arrangement includes a pair of handles extending from both sides of the impact protective arrangement.

8. The bulletproof pillow according to claim 7, which is housed in an outer fabric casing including at least one opening through which the at least one handle extends outwardly.

9. The bulletproof pillow according to claim 2, wherein the layers of the first element and the second element are formed by interlacing yarn of fibres selected from the group consisting of a meta-aramid fibre, a para-aramid fibre, an ultra-high molecular weight polyethylene fibre, a polyethylene terephthalate fibre, a cellulose fibre, a polyamide fibre, a mixture of para-aramid fibres and meta-aramid fibres, a mixture of para-aramid fibres and carbon fibres, and a combination thereof.

10. The bulletproof pillow according to claim 2, wherein the layers of the first element and the second element are formed by sintering a powder of a material selected from the group consisting of meta-aramids, para-aramids, ultra-high molecular weight polyethylene, polyethylene terephthalate, a cellulose, a polyamide, a mixture of para-aramid and meta-aramid, a mixture of para-aramid and carbon, and a combination thereof.

11. The bulletproof pillow according to claim 2, wherein the layers of the first element and the second element comprise ultra-high molecular weight polyethylene that is formed into a layer having an area density of between 50±8 gram per square metre (g/m²) and 300±8 gram per square metre (g/m²) and having a thickness of between 0.07±0.02 millimetres (mm) and 0.40±0.02 millimetres (mm).

12. The bulletproof pillow according to claim 11, wherein the first element comprises at least 14 ultra-high molecular weight layers, the plurality of ultra-high molecular weight layers being grouped into sets, wherein several sets form the first element, the ultra-high molecular weight layers of each set being attached to one another and wherein the second element has a thickness of between 0.5 millimetres (mm) and 5 millimetres (mm) and wherein the third element has a thickness of between 1 millimetre (mm) and 7 millimetres (mm).

13. The bulletproof pillow according to claim 1, wherein the pair of cushioned supports comprises a filler material which is enclosed in a fabric cover, the filler material being selected from the group consisting of high-density foam such as memory foam, wool, polyester, feathers, cotton, and down fibres, or any combination thereof and wherein the bulletproof pillow is in the form of a mattrass or carpet wherein the cushioned supports comprise several layers of high-density foam, support foam, memory foam, or coil springs, or any combination thereof.

14. The bulletproof pillow according to claim 1, which further includes an additional protective layer which is either housed within the impact protective arrangement or removably secured to the impact protective arrangement, the additional protective layer being in the form of a ballistic plate which is supported in a plate carrier incorporated in the impact protective arrangement.

15. The bulletproof pillow according to claim 3, wherein the impact protective arrangement comprises:
A) two second elements, which are arranged at an uppermost layer and lowermost layer of the first element such that the first element is located between the two second elements.

16. The bulletproof pillow according to claim 3, wherein the impact protective arrangement comprises:
B) one second element and two first elements, and wherein the second element is positioned between the two first elements.
